(19) United States
(12) Patent Application Publication
(10) Pub. No.: US 2013/0061136 A1
(43) Pub. Date: Mar. 7, 2013

(54) METHOD AND SYSTEM FOR THE REMOTE CONTROL OF A DISPLAY SCREEN

(71) Applicant: Olivier Cadou, Paris (FR)

(72) Inventor: Olivier Cadou, Paris (FR)

(73) Assignee: Olivier Cadou, Paris (FR)

(21) Appl. No.: 13/583,488

(22) PCT Filed: Feb. 25, 2011
(86) PCT No.: PCT/FR2011/050394

§ 371 Date: Nov. 14, 2012

(30) Foreign Application Priority Data
Mar. 9, 2010 (FR) 1051706

(51) Int. Cl. G06F 17/24

(52) U.S. Cl. 715/255

(57) ABSTRACT

The invention relates to a method and system for the remote control of a display screen, said system being initiated by a remote display server that communicates with at least one terminal by means of at least one communication channel that is set up through an information and/or telephone network. Said method is characterized by the following steps: placing a “Documents & Locations/Configurations” table and a “User/Configuration” table on the display server; loading and/or automatically converting documents on the server and/or on other locations then updating a document-loading table; storing documents on the server and on other locations; placing an application on the terminal of a user, thus making it possible for the documents to be read, updated, and synchronized; testing, by means of the server, the bandwidth of each user, and then updating the “User/Configuration” table; and sending documents in synchronous or asynchronous mode to the users, thus enabling the documents to be self-adaptable.

The present invention relates in a general manner to the domain of telecommunications, and relates more particularly to a method and a system for the remote control of a display screen, initiated by at least one server, referred to as the remote presentation server, communicating with at least one communication terminal, referred to as the user, via at least one communication channel set up via a computer network and/or telephony network.

It is known for business partners to be put in contact with one another via telephone conferencing systems or via videoconferencing systems implemented on specific network infrastructures based, for example, on the ISDN standard.

Many Web conferencing services have also been developed, providing simple and effective means for enhancing these working sessions.

These services, in which users, each one using his computer or mobile terminal equipped with ad hoc resources (typically a browser and an Internet connection), communicate with one another, in real time, by using the communication protocols of the Internet network, are in fact particularly suitable for holding virtual meetings between remote users.

A Web conferencing service thus enables the requirements for document sharing to be simply met, in contexts whereby users need to meet to visualize a presentation, or information, but cannot do so in the same locality.

In addition to this functionality for sharing applications or files of all types, Web conferencing services can also offer flow management functionalities for audio, video or instant messaging.

The different telecommunications solutions described above, which can moreover be implemented in combination, thus offer a whole range of functionalities enabling the holding of virtual meetings or virtual training with remote persons.

These different solutions can be classified into three categories:
Those which require the installation or downloading of an application (plug-in, applet, etc.) onto the terminal of all of the users, who may be either presenters or participants. They have the disadvantage of very often being refused by the participants for reasons of security or confidentiality (a doctor, for example, will refuse to follow a remote presentation from his computer, fearing that an installation will disrupt the operation of his daily work tool or will access confidential files of his patients which it contains).
Those which require the installation or downloading of an application (plug-in, applet, etc.) onto the terminal of some of the users, i.e. the presenters only.
Those which require no installation and which have the advantage of being accepted by everyone.

Existing solutions for the remote control of a display screen often come up against operational difficulties due to the heterogeneous nature of the computer environment and the network of the users. As a result, a remote presentation becomes very complicated, or even impossible.

The following two cases may therefore frequently occur:
A user chooses a document to share with the other users on their respective display screens, but the chosen document cannot be displayed in its entirety (size, animation, functionalities) and/or cannot be displayed in a reasonable time on the display screen of all users, because some users do not have the suitable configuration or sufficient bandwidth for that purpose.
A user wishing to share documents with the other users on their respective display screens cannot do so because he himself does not have sufficient bandwidth for that purpose.

In this context, there is a need for a solution enabling remote control of a display screen in a manner which is simple and transparent to the user, for any remote communication session implemented with at least one user, regardless of the communication method on which it is based, i.e. telephone, Web, audio or video, implemented or not implemented in combination and overcoming the above-mentioned difficulties, without installation on the user terminals in the first case and without installation on the terminals of the participant users in the second case.

The invention aims to meet this need. This object is achieved through the use of a method in accordance with the generic definition given in the preamble above, more particularly characterized in that it includes the steps of:
implementation, on the presentation server (20), of a table, referred to as the Documents & locations/Configurations table, providing correspondence between the formats of documents to be presented remotely or the media to be used (different formats for live video, for example: size, number of images per second, number of bits per pixel, compression rate), their locations and the required configurations of the terminals of the users to display these documents or broadcast these media, and also a User/Configuration table containing the different configurations of the users,
loading and/or automatic conversion of documents on the presentation server by a user presenting these documents and possibly loading and/or conversion at other locations, then updating of a document-loading table with an order of preference for the different versions of the same document,
storage of the documents to be shared on the presentation server and at other locations (for example, mass memory of a peripheral of the user: local hard disk, hard disk of a server of his Intranet network; other server, etc.) with an order of preference for the different locations of the same document or versions of the same document.
implementation of an application (mainly a local web server) on the terminal of a user, enabling the reading of the documents to be shared from said other locations, updating of the documents to be shared and synchronization of said documents with those present on the presentation server,
testing, by the remote presentation server, of the bandwidth (uplink and downlink) of each user and reading of his software configuration, then updating of the User/Configuration table,
sending to the users of the documents or media in centralized synchronous mode or decentralized synchronous mode or centralized asynchronous mode or decentralized asynchronous mode according to the content of said documents or media and the configuration of the terminal of the users, enabling an auto-adaptation of the documents or media to be shared according to the configuration of each user (choice of different formats and locations of documents according to the configurations of the users, and parameterization of the broadcast media: modification of the size of live video, of its number of images per second, its number of colors, its compression rate).

According to the invention, the Documents & locations/Configuration table is updated regularly by the server or by the users.

According to the invention, the Users/Configurations table is updated regularly by the server or by the users.

According to the invention, the document-loading table is updated regularly by the server or by the users.

According to one embodiment, the loading of a document by a user includes the loading of said document in a plurality of versions, in different formats, on the presentation server and possibly at other locations (local mass memory, Intranet server, other Internet server, etc.).

According to one embodiment, the step of conversion includes the automatic generation of the different document versions using a format converter.

According to one embodiment, the remote presentation server proposes the downloading, onto a peripheral of the terminal of the user or to other locations, of one or more versions, in different formats, of the same document.

According to one embodiment, the user indicates a minimum reference bandwidth for each version of the document or the server automatically calculates said minimum bandwidth.

According to one embodiment of the invention, the step of testing the bandwidth (uplink and downlink) of the user by the server is implemented by sharing invisible documents of unknown weight, then by calculating the time taken for the reception of said invisible documents by the user, referred to as the ‘downlink bandwidth’, or by the server, referred to as the ‘uplink bandwidth’.

According to one embodiment, the step of sending the document to be shared to the user includes an auto-adaptation of the version of the document according to the user configuration.

According to one embodiment, the document sent to the users by the server is the document adapted to the smallest configuration of all of the configurations of said users, corresponding to the centralized synchronous mode.

According to a different embodiment, the same document adapted to the smallest configuration of all of the configurations of said users can be sent to the users from different locations, corresponding to the sending of the document from a location adapted to the configuration of each of the users, corresponding to the decentralized synchronous mode.

According to a different embodiment, the document sent to the users by the server is the document best adapted to each of the configurations of the users, corresponding to the centralized asynchronous mode.

According to a different embodiment, the document best adapted to each of the configurations of the users can be sent to the users from different locations, corresponding to the sending of the document from a location adapted to the configuration of each of the users, corresponding to the decentralized asynchronous mode.

According to a different embodiment, which may or may not be taken in combination with the preceding embodiments, the server includes means for connection to a telephone communication between the communication terminals.

According to a different embodiment, which may or may not be taken in combination with the preceding embodiments, the connection means include means for connection to a server hosting a Web conferencing application in which the communication terminals participate.

The invention further relates to a server for controlling a display screen, referred to as the remote presentation server, communicating with at least one communication terminal, set up via a computer network and/or telephony network, including registration and authentication of the users and being characterized in that it includes:
means for implementing a Documents locations/Configurations table, providing correspondence between the formats of documents to be presented remotely or the media to be used, their locations and the required configurations of the terminals of the users to display these documents or broadcast these media, and also a User/Configuration table containing the different configurations of the users,
means for loading and/or automatic conversion of the documents on the presentation server and/or at other locations, and means for updating a loading table,
means for storing at locations other than the remote presentation server of the documents to be shared,
means for implementing an application on the terminal of a user enabling the reading of the documents to be shared from locations other than the server, means for updating these documents and means for synchronizing said documents with those present on the presentation server,
means for testing and updating, on the server, the bandwidth of each user and means for reading his software configuration and means for updating the User/Configuration table,
means for sending the documents in synchronous or asynchronous mode to the users, enabling an auto-adaptation of the documents or media to be shared according to the configuration of each user.

According to a different embodiment, which may or may not be taken in combination with the preceding embodiments, the remote presentation server can be a server system including:
at least one user authentication server,
at least one remote presentation server,
at least one data conversion server, including means for receiving data from the remote presentation server and means for compressing said data in a predetermined format,
at least one data storage and retrieval server, including means for receiving documents, compressed or otherwise, and means for storing and delivering said documents.

The method according to the invention preferably includes a prior step of registration with a remote sharing service, during which a user connects to a computer server to identify himself to the service and in return receives personalized access data to access the service.

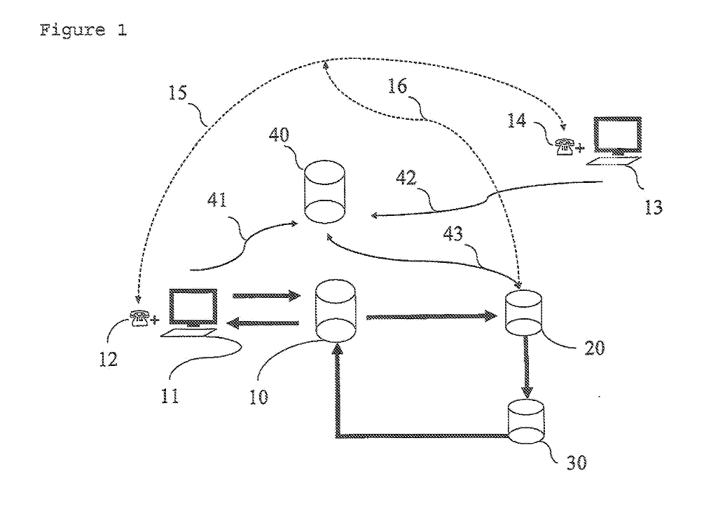

The system for the remote control of a display screen described in FIG. 1 includes a computer server 10, provided to receive the registration requests of users wishing to use the remote control service. In fact, any user wishing to use the service enabling the remote control of a display screen or, more particularly, to share a document with other remote users must, in a prior step, register and identify himself in order to obtain in return personalized access data to access the service.

The computer server 10 includes, for example, a Web server 40 hosting an Internet site to which the user connects via, for example, his personal computer, to supply identification information by using, for example, an identification form to be completed. The identification data supplied by the user include, for example, his personal details (name, first name, address, etc.). At the end of this prior step of registration with the remote control service, the server 10 sends back to the user personalized access data to access the service, including, for example, a user code (login) associated with a password, with which the user will be able to access his personal account on the site, allowing him to register and load documents in different formats onto the server. As a variant, the access by the user to the different functionalities will also be able to be allowed through the sending of an SMS (“Short Message Service”), an e-mail or a voice call to the server.

The data conversion server 30 is then adapted to perform a compression operation on the data (documents, videos, etc.) in a predetermined format. This data compression format may be selected by the server 20 from a plurality of available formats, during the sending of the data to the users.

Finally, once converted, the data are intended to be transmitted to their final destinations, comprising storage and retrieval servers, for example the Web server 40 which was used for registration, or a voice or video server, to be made available to the user.

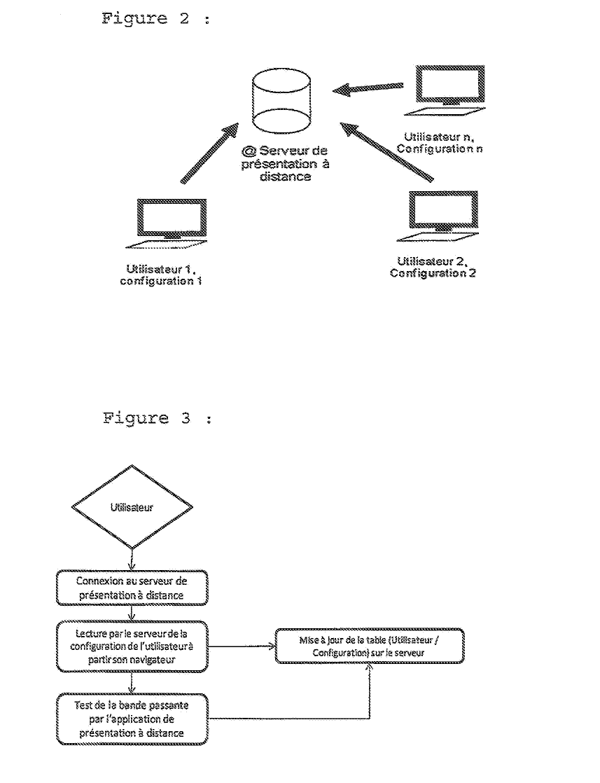

Other characteristics and advantages of the present invention will become more clearly evident by reading the following description, given as an illustrative and non-limiting example, and provided with reference to the attached tables and drawings (FIGS. 2 and 3).

FIG. 2 shows a system for the remote control of a display screen initiated by a server, referred to as the remote presentation server 20, with at least one communication terminal, via at least one communication channel set up via a computer and/or telephony network. The latter will be described below in the context of remote sharing of documents between a plurality of users.

The remote presentation server 20 is adapted to supply registered and authenticated users with the documents according to their configuration.

The remote presentation server 20 according to the invention includes means for updating a Documents & locations/Configurations correspondence table and a Users/Configurations table, means for loading, storing and automatic conversion of the documents, including the updating of a loading table, means for collecting and storing user configuration information, means for testing and updating the bandwidth of the users and means for sending documents in centralized or decentralized synchronous mode, or centralized or decentralized asynchronous mode, to the users.

More precisely, the server 20 allowing the remote presentation has a regularly updated correspondence table, as outlined in Table 1 at the end of the description. The table includes, at the input, the list of different documents/media formats which can be shared remotely and their locations, and, at the output, the configurations required on the side of the users to visualize them entirely within a reasonable time. The configuration parameters required on the side of the users are the terminal type, the operating system and its version, the screen resolution, the plug-ins and installed applications and their versions, the size of the bandwidth, etc. The list is not exhaustive and may include any type of parameter enabling recognition of the specific features of the user configuration in order to optimize the transmitted information at the output. All of these configuration data are collected by the presentation server which then updates a Configurations/Users table.

When a user downloads documents which he wishes to share with other users onto the server 20, said server 20 will allow him to load a plurality of versions of the document in different formats, or it will allow him to load alternative versions of the document in order to update a loading table for said documents. Table 2 describes an example of a document-loading table (presented at the and of the description).

If the user wishes to load a video, a plurality of versions, of different sizes and different qualities (number of images per second, number of colors), compressed or otherwise, by streaming or otherwise, can be loaded as alternative versions.

Moreover, the server 20 may propose to the user locating versions in possibly different formats on a different peripheral, for example the memory of his computer or personal assistant.

The remote presentation server can automatically generate versions of documents using a format converter. The server 20 asks the user to indicate the bandwidth required for the different versions of documents loaded on the server or, if it is able to do so, calculates it automatically. The bandwidth required for each document is evaluated according to its content and therefore its weight. The server 20 asks the user to classify in order of preference, in terms of quality, the different formats loaded for the same document. Moreover, the server asks the user if the document must be presented in synchronous mode, i.e. sent to all users of the same document adapted to the smallest configuration of all of the configurations, or presented in asynchronous mode, i.e. an optimum version of the document adapted sent to each of the users.

The connection of the user to the server 20 is set up via a network browser tool (for example an Internet browser). Internet browsers have agents allowing them to collect information on the configuration of their users, i.e. the terminal type (PC, Mac, etc.), the browser type (make and version of the Internet browser, for example), the display screen resolution, the installed plug-ins (Adobe PDF, Adobe Flash, etc.) and their versions, the installed Java version, etc. The remote presentation server will read the collected information, then store it in the Users/Configurations table (Table 3) in order to be able to use it subsequently. FIG. 3 shows the different steps relating to the updating of the bandwidth of the users in the User/Configuration table (presented at the end of the description). In order to test the bandwidth of the users, the server 20 will share invisible documents, of unknown weight, with said users and calculate the time taken for the reception of said documents by each of the users and by the server itself. This test allows the server 20 to determine in an approximate manner the size of the bandwidth (uplink and downlink) available for each user of the remote presentation service. The size of the bandwidth (for uploading and downloading) will be added to the configuration of each user in the User/Configuration table. During the remote presentations of the documents, the calculation of the bandwidth available for each user can be re-updated regularly by the server.

When the server receives the request to display a document from a user, it will consult the “Documents & location/Configuration” correspondence table, the “User/Configuration” table and the document-loading table. Then, according to the data available in these tables relating to the different configurations of the different users, the server can send the document(s) in centralized or decentralized synchronous or asynchronous mode.

As shown in Table 4, the synchronous mode sends the same document to all users, adapted to the smallest configuration of the users connected to the server. This request may be made by the remote presentation server which then sends the document or may be transmitted (cf. Table 5) by the remote Presentation server to a different server (for example a local server) so as to be made from a different location of said document (for example the mass memory of the user terminal or one of the mass memories present on a server of his Intranet server).

Table 5 describes the asynchronous mode, which consists of the sending by the presentation server of a document adapted to the configuration of each user. In fact, the presentation server has means for auto-adaptation of the shared content according to the configuration of the users and, inter alia, the size of the bandwidth of the users.

Example of Remote Document Presentation Involving Different User Typologies:

So that the sales staff and trainers of the company K can give remote sales presentations, an administrator of the company K will install 3 versions of the same presentation for them on the remote presentation server, classified in order of preference: an HTML presentation containing Adobe Flash version 10 animations and two alternative versions, one HTML with GIF animations for users who do not have the plug-in or the correct version of the Adobe Flash Player plug-in installed on their machine, and a second version of the content scaled down for a Smartphone (iPhone, BlackBerry, etc.).

At the time of loading, the server also offers him the possibility of storing his documents on the mass memory of his terminal, which he does with the HTML version containing Adobe Flash version 10 animations on the machines of the three future users, and of installing an application allowing the content to be read in decentralized mode.

Centralized Synchronous Mode

One of the sales staff in question decides to give a first remote presentation from his home to a customer. He connects to the server and his customer does the same. The server detects that he is working on a PC, under Microsoft Windows XP, that he has connected with Microsoft Internet Explorer 7.0, that his screen resolution is 1024×768 and that he has notably the Flash 10.0 plug-in installed on his machine.

His customer is working on a Mac, under OS X, he has connected with Firefox 6.0, his screen resolution is 1024×768 and he has the Flash 9.0 plug-in installed on his machine.

The bandwidth test carried out shows that the two connected users both have high-speed ADSL.

The server will therefore automatically update his browser menu to provide him with the HTML version with GIF animations so that he can share it, in synchronous mode (his customer and he himself see exactly the same presentation on the screen), with his customer who does not have the correct Flash version to display the Flash version on the screen.

Decentralized Synchronous Mode

This same salesman leaves home, gets into a taxi to take him to the railway station and decides to give a remote presentation to another of his customers during the journey. He connects to the server using the application installed on his portable computer and his customer connects directly to the presentation server using his normal browser. The server detects that the salesman is working on a PC, under Microsoft Windows XP, that he has connected using Microsoft Internet Explorer 7.0, that his screen resolution is 1024×768, and that he has notably the Flash 10.0 plug-in installed on his machine.

His customer is also working on a PC, under Microsoft Windows XP, he has connected using Microsoft Internet Explorer 7.0, his screen resolution is 1280×1024 and he has notably the Flash 10.0 plug-in installed on his machine.

The bandwidth test carried out shows that the salesman has a very low bandwidth (probably 3G or less) and that his customer has high-speed ADSL.

The server therefore switches automatically to asynchronous mode and the local application present on his terminal updates the navigation menu of the salesman so that, when the latter uses it to share a document, his browser looks for the corresponding document for him located on his hard disk (rather than requiring it to be downloaded from the server) and sends an instruction to the server so that the latter provides his customer with the corresponding document.

In this precise example, the salesman and his customer will see exactly the same document on their respective screens, one having loaded it from his hard disk, the other from the server.

The salesman therefore overcomes the difficulties associated with his very low bandwidth, since he no longer downloads each document, and sends or receives only instructions from the server.

Decentralized Synchronous Mode

Finally, this same salesman decides to carry out some training with one of his colleagues, who has the same configuration as he does, and an equally low bandwidth (less than 3G).

The server therefore switches automatically to decentralized synchronous mode and the navigation menus of the two salesmen are updated so that the two applications search for the documents to be shared on their respective mass memories (rather than require them to be downloaded from the server). Thus, the two users will see exactly the same document on their respective screens as if they had connected at high speed, each salesman having loaded it from his hard disk. They therefore overcome the difficulties associated with their insufficient, bandwidth, since they no longer download any document, and send or receive only instructions from the server (for display, but also for the remote reproduction of events: movement of the mouse, launching of animations, etc.).

TABLE 1

| | | Required configuration | | | | | |
|---|---|---|---|---|---|---|---|
| | | | | | Required | Required | |
| Document/media | | | | | uplink | downlink | Required |
| format | Location | Plug-in | Browser | ′″ | bandwidth | bandwidth | hardware |
| HTML | Server | | | | | 3G (1 Mbit/s) | |
| HTML | Local | | | | | Modem (15 kbit/s) | |
| | hard | | | | | | |
| | disk | | | | | | |
| HTML + Adobe | Server | Adobe | | | | Wifi | |
| Flash v10 | | Flash | | | | minimum | |
| animations | | Player | | | | (5 Mbit/s) | |
| | | 10.0 | | | | | |
| Microsoft | Server | | Microsoft | | | 3G (1 Mbit/s) | |
| PowerPoint | | | IE | | | | |
| | | | version | | | | |
| | | | 5.0 and | | | | |
| | | | later | | | | |
| Adobe Flash | Server | Adobe | | | | Wifi | |
| version 10.0 | | Flash | | | | minimum | |
| | | Player | | | | (5 Mbit/s) | |
| | | 10.0 | | | | | |
| Adobe Flash | Server | Adobe | | | | Wifi | |
| version 9.0 | | Flash | | | | minimum | |
| | | Player | | | | (5 Mbit/s) | |
| | | 9.0 or | | | | | |
| | | later | | | | | |
| Video 640 × 480, | Server | Adobe | | | | High- | |
| 8 bits, 20 | | Flash | | | | speed | |
| images per | | Player | | | | ADSL (20 Mbit/s) | |
| second | | version | | | | | |
| | | 7.0 or | | | | | |
| | | later | | | | | |
| Video 640 × 480, | Local | Adobe | | | | Modem (15 kbit/s) | |
| 8 bits, 20 | hard | Flash | | | | | |
| images per | disk | Player | | | | | |
| second | | version | | | | | |
| | | 7.0 or | | | | | |
| | | later | | | | | |
| Adobe PDF | Server | Adobe | | | | 3G (1 Mbit/s) | |
| | | PDF | | | | | |
| | | Reader | | | | | |
| Live Video | | Adobe | | | 500 kbit/s | 500 kbit/s | Webcam + audio |
| 160 × 120 with | | Flash | | | | | card + speaker |
| Voice over IP | | Player | | | | | systems + |
| | | version | | | | | integrated |
| | | 7.0 or | | | | | microphone or |
| | | later | | | | | headset |
| | | | | | | | microphone |
| Live Video | | Adobe | | | 800 kbit/s | 800 kbit/s | Webcam + audio |
| 320 × 240 with | | Flash | | | | | card + speaker |
| Voice over IP | | Player | | | | | systems + |
| | | version | | | | | integrated |
| | | 7.0 or | | | | | microphone or |
| | | later | | | | | headset |
| | | | | | | | microphone |
| Smartphone/PDA | Server | | | | | | Smartphone/PDA |
| document | | | | | | | (iPhone, |
| | | | | | | | BlackBerry, |
| | | | | | | | etc.) |

### Example of Format/Location/Required Configuration Correspondence Table

TABLE 2

| | | Format of | | | |
|---|---|---|---|---|---|
| | | documents | | | |
| | | contained | | Required | |
| File name | Date | in the file | Location | bandwidth | Order |
| 20090201_ | Dec. 19, 2009 | HTML | http://Serveur007.kadrige.com/HTML | Wifi | 2 |
| PRESENTA- | | | | minimum | |
| TION_FR_OC | | | | (5 Mbit/s) | |
| HTML | | | | | |
| 20090201_ | Dec. 19, 2009 | HTML | F:/MyKadrige/Content/HTML | Modem | 2 |
| PRESENTA- | | | | (15 kbit/s) | |
| TION_FR_OC | | | | | |
| HTML | | | | | |
| 20090201__ | Dec. 18, 2009 | HTML + | http://Serveur007.kadrige.com/HTML-FL10 | Wifi | 1 |
| PRESENTA- | | Adobe Flash | | minimum | |
| TION_FR_OC | | v10 | | (5 Mbit/s) | |
| HTML-FL | | animations | | | |
| 20090201_ | Dec. 17, 2009 | HTML + | F:/MyKadrige/Content/HTML-FL10 | Modem | 1 |
| PRESENTA- | | Adobe Flash | | (15 kbit/s) | |
| TION_FR_OC | | v10 | | | |
| HTML-FL | | animations | | | |

### Example of Document-Loading Table

TABLE 3
Configuration

| | | | | Plug- | | Uplink | Downlink | |
|---|---|---|---|---|---|---|---|---|
| User name | Password | Date | Browser | in | ′″ | bandwidth | bandwidth | Hardware |
| ocadou | ******* | 15/01/09 | Microsoft | Adobe | | 430 kbit/s | 850 kbit/s | Webcam |
| | | | IE | Flash | | | | |
| | | | version | Player | | | | |
| | | | 8.0 | 10.0 | | | | |
| vdubrau | ******* | 17/01/09 | Safari | Adobe | | 750 kbit/s | 7 Mbit/s | |
| | | | | Flash | | | | |
| | | | | Player | | | | |
| | | | | 9.0 | | | | |
| sprin | ******* | 16/01/09 | Firefox | Adobe | | 750 kbit/s | 5.6 Mbit/s | |
| | | | | Flash | | | | |
| | | | | Player | | | | |
| | | | | 10.0 | | | | |
| mlebreton | ******* | 15/01/09 | Chrome | Adobe | | 900 kbit/s | 11 Mbit/s | |
| | | | | Flash | | | | |
| | | | | Player | | | | |
| | | | | 10.0 | | | | |
| Svaid | ******* | 15/01/09 | Safari | | | 170 kbit/s | 250 kbit/s | iPhone |

### Example of Users/Configuration Table

1. A method for the remote control of a display screen initiated by a server (20), referred to as the remote presentation server, communicating with at least one terminal (11, 13), via at least one communication channel set up via a computer network and/or telephony network, characterized by the following steps:
implementation on the presentation server ( ) of a table, referred to as the Documents & locations/Configurations table, providing correspondence between the formats of documents to be presented remotely or the media to be used, their locations and the required configurations of the terminals of the users to display these documents or broadcast these media, and also a User/Configuration table containing the different configurations of the users,
loading and/or automatic conversion of documents on the presentation server by a user presenting these documents and possibly loading and/or conversion at other locations, then updating of a document-loading table with an order of preference for the different versions of the same document,
storage of the documents to be shared on the presentation server and at other locations,
implementation of an application on the terminal of the user enabling the reading of the documents to be shared from said other locations, updating of the documents to be shared and synchronization of said documents with those present on the presentation server,
testing, by the remote presentation server, of the bandwidth of each user and reading of his software configuration, then updating of the User/Configuration table,
sending to the users of the documents or media in synchronous mode or asynchronous mode according to the content of said documents or media and the configuration of the terminal of the users, enabling an auto-adaptation of the documents or media to be shared according to the configuration of each user.

2. The method for the remote control of a display screen as claimed in claim 1, characterized in that it includes an optional prior step of registration and authentication of the users.

3. The method as claimed in claim 1, characterized in that the Documents & locations/Configuration table is updated regularly by the server or by the users.

4. The method as claimed in claim 1, characterized in that the Users/Configurations table is updated regularly by the server or by the users.

5. The method as claimed in claim 1, characterized in that the document-loading table is updated regularly by the server or by the users.

6. The method as claimed in claim 1, characterized in that the step of the loading of a document by a user includes the loading of a plurality of versions, in different formats, of the same document on the presentation server.

7. The method as claimed in claim 1, characterized in that it includes a step of loading, onto a peripheral of the terminal of the user, of one or more versions, in different formats, of the same document.

8. The method as claimed in claim 1, characterized in that the conversion step includes the automatic generation of the different versions of documents using a format converter.

9. The method as claimed in claim 1, characterized in that the user indicates a minimum reference bandwidth for each version of the document or the server automatically calculates said minimum bandwidth.

10. The method as claimed in claim 1, characterized in that the step of testing the bandwidth of the user by the server is implemented by sharing invisible documents of unknown weight, then by calculating the time taken for the reception of said invisible documents by the user, referred to as the ‘downlink bandwidth’, or by the server, referred to as the ‘uplink bandwidth’.

11. The method as claimed in claim 1, characterized in that the step of sending the document to be shared to the user includes an auto-adaptation of the version of the document according to the user configuration.

12. The method as claimed in claim 11, characterized in that the document sent to the users by the server is the document adapted to the smallest configuration of all of the configurations of said users, corresponding to the synchronous mode.

13. The method as claimed in claim 11, characterized in that the document sent to the users by the server is the document best adapted to each of the configurations of the users, corresponding to the asynchronous mode.

14. The method as claimed in claim 11, characterized in that the document is sent to the users from different locations, corresponding to the sending of the document from a location adapted to the configuration of each of the users, corresponding to the decentralized mode.

15. A server for the remote control of a display screen, referred to as the remote presentation server, communicating with at least one communication terminal set up via a computer and/or telephony network, including means for registration and authentication of the users, and being characterized in that it includes:
means for implementing a Documents & locations/Configurations table, providing correspondence between the formats of documents to be presented remotely or the media to be used, their locations and the required configurations of the terminals of the users to display these documents or broadcast these media, and also a User/Configuration table containing the different configurations of the users,
means for loading and/or automatic conversion of the documents on the presentation server and/or at other locations, and means for updating a loading table,
means for storing at locations other than the remote presentation server of the documents to be shared,
means for implementing an application on the terminal of a user enabling the reading of the documents to be shared from locations other than the server, means for updating these documents and means for synchronizing said documents with those present on the presentation server,
means for testing and updating the bandwidth of each user on the server and means for reading his software configuration and means for updating the User/Configuration table,
means for sending the documents in synchronous or asynchronous mode to the users, enabling an auto-adaptation of the documents or media to be shared according to the configuration of each user.

16. A system for the remote control of a display screen, including at least one server for registration and authentication of the users, characterized in that it further includes at least one remote presentation server (20) as claimed in claim 15,
at least one data conversion server (30), including means for receiving documents and means for converting said documents into different formats,
at least one server for storing user configuration information,
at least one server for testing the bandwidth of the users, then updating the User/Configuration correspondence table,
at least one server for the auto-adaptation of the documents to be shared according to the configuration of each user.

17. The method as claimed in claim 12, characterized in that the document is sent to the users from different locations, corresponding to the sending of the document from a location adapted to the configuration of each of the users, corresponding to the decentralized mode.

18. The method as claimed in claim 13, characterized in that the document is sent to the users from different locations, corresponding to the sending of the document from a location adapted to the configuration of each of the users, corresponding to the decentralized mode.
